(19) United States
(12) Patent Application Publication
(10) Pub. No.: US 2016/0148153 A1
(43) Pub. Date: May 26, 2016

(54) OPTIMIZING NETWORK YIELD DURING FREIGHT BOOKING

(71) Applicant: International Business Machines Corporation, Armonk, NY (US)

(72) Inventors: Francisco Barahona, White Plains, NY (US); Mark D. Bedeman, Barcelona (ES); Parijat Dube, Yorktown Heights, NY (US); Joao P.M. Goncalves, Wappingers Falls, NY (US); Shilpa N. Mahatma, Mohegan Lake, NY (US); Milind R. Naphade, Fishkill, NY (US)

(21) Appl. No.: 14/624,698

(22) Filed: Feb. 18, 2015

(30) Foreign Application Priority Data
Nov. 21, 2014 (EP) 14382462.1

(51) Int. Cl. G06Q 10/08; G06Q 40/08

(52) U.S. Cl. CPC G06Q 10/08355; G06Q 40/08

(57) ABSTRACT

Booking information including destination and origin and specifying a desired multi-modal freight shipment is obtained from a user; based on same and on route information from a carrier database, a plurality of feasible multi-modal routes for the desired freight shipment are generated with a route enumeration module. Based on cost information from the carrier database, cost for each of the feasible multi-modal routes is computed with a cost estimation sub-module of a metric computation module. Based on transit time information from the carrier database, transit time for each of the feasible multi-modal routes is computed with a transit time estimation sub-module of the metric computation module. Based on the cost for each of the feasible multi-modal routes and the transit time for each of the feasible multi-modal routes, multi-objective optimization under uncertainty is carried out with an optimization module, to obtain one or more preferred feasible multi-modal routes.

### CROSS-REFERENCE TO RELATED APPLICATIONS

This application claims foreign priority to EPO Application number 14382462.1, filed 21 Nov. 2014, the complete disclosure of which is expressly incorporated herein by reference in its entirety for all purposes.

### BACKGROUND

The present invention relates to the electrical, electronic and computer arts, and, more particularly, to travel and transportation technologies, and the like.

Freight transportation is often multi-modal, i.e., more than one mode of transportation is employed. In addition, the various modes of transportation are often provided by different companies. This leads to significant complexity in terms of the choices a booking agent has when trying to book a shipment. Booking in freight transportation is a manual process that involves several steps such as finding available transportation, finding rates for that transportation, comparing different possible transportation choices, submitting request for transportation to carriers, etc. This process is slow, error prone, and does not guarantee that the best choices for transportation are even considered before the booking decision is made.

### SUMMARY

Principles of the invention provide techniques for optimizing network yield during freight booking. In one aspect, an exemplary method includes the step of obtaining, from a user, booking information specifying a desired multi-modal freight shipment. The information includes at least destination and origin. A further step includes, based on the booking information and route information from a carrier database, generating, with a route enumeration module, a plurality of feasible multi-modal routes for the desired freight shipment. Still further steps include, based on cost information from the carrier database, computing cost for each of the feasible multi-modal routes with a cost estimation sub-module of a metric computation module; and, based on transit time information from the carrier database, computing transit time for each of the feasible multi-modal routes with a transit time estimation sub-module of the metric computation module. An even further step includes, based on the cost for each of the feasible multi-modal routes and the transit time for each of the feasible multi-modal routes, carrying out multi-objective optimization under uncertainty with an optimization module, to obtain one or more preferred ones of the feasible multi-modal routes.

In another aspect, an exemplary apparatus includes a memory including a carrier database and a plurality of distinct software modules. The plurality of distinct software modules in turn include an input-output module, a route enumeration module, an optimization module, and a metric computation module having a cost estimation sub-module and a transit time estimation sub-module. At least one processor is coupled to the memory, and is operative to carry out or otherwise facilitate any one, some, or all of the method steps disclosed herein.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects; for example, the development of an automatic process to gather information from outside sources such as websites and the data mapping necessary to store the data in a standardized form for easy access.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 presents an exemplary booking system according to an aspect of the invention;

FIG. 2 presents an exemplary booking message flow according to an aspect of the invention;

FIG. 3 depicts an exemplary flow chart for booking according to an aspect of the invention;

FIG. 4 depicts a computer system that may be useful in implementing one or more aspects and/or elements of the invention; and

FIG. 5 shows exemplary dates used to define a time window according to an aspect of the invention.

### DETAILED DESCRIPTION

As noted, freight transportation is often multi-modal, i.e., it uses more than one mode of transportation. In addition, the various modes of transportation are often provided by different companies. This leads to significant complexity in terms of the choices a booking agent has when trying to book a shipment. Booking in freight transportation is currently a manual process that involves several steps such as finding available transportation, finding rates for that transportation, comparing different possible transportation choices, submitting request(s) for transportation to carriers, etc. This process is slow, error prone, and does not guarantee that the best choices for transportation are even considered before the booking decision is made.

While there are, in the marketplace, solutions to automate some of the steps of booking in freight transportation, there is not any current solution that incorporates all steps.

One or more embodiments advantageously provide an integrated system to automate the booking process. Indeed, one or more embodiments automate the process of booking freight transportation. One or more embodiments provide an integrated system that provides the booking agent the following functionality:
Decision support tool
Auto-quoting tool
Automated Booking tool
Booking Analytics support to provide value to customer (for example, recommend cost-effective changes to the initial decision constraints)

One or more embodiments are implemented as software that takes inputs from the booking agent, uses data stored in a database and also obtained by electronic transfer from other systems (for example, by connecting to a website where public relevant information is available and downloading such information and/or by using Electronic Data Interchange (EDI) to obtain relevant and up to date information from carriers and other partners), and provides recommendations regarding possible transportation alternatives and their corresponding rates. One or more embodiments allow the booking agent to select a particular transportation solution and automatically proceed with the booking.

Some of the advantages of the system are:
Dynamic route creation and cost calculation
   Finding solutions fast
   Finding the best options from a large number of combinations (not possible for a human being)
Automatic Business rules and contract enforcement
Accounting for real time information regarding the state of the network
Adapting to day-to-day changes in the network, market, carrier
More value to the shipper because the system can propose transportation rates that are better than the rates the shipper may have with specific carriers

One or more embodiments provide a system to automate the booking process. The booking agent inputs, into the system, the data that defines the requirements of the booking. For example, the shipment cannot depart from its origin before a certain date or/and it must arrive at the destination by a certain date. The input from the user can include many types of constraints such as a limit on the number of transportation modes, the exclusion and/or inclusion of specific carriers and ports, and the like.

A system according to a non-limiting exemplary embodiment provides support for any service type (such as Door-to-Door) and includes all the transportation needed to fulfill the service type requirement. Data regarding the existing transportation, such as schedules and rates, is stored in a database, which is continuously updated with the latest information. The exemplary system accepts programmable selection criteria used to determine the best transportation options proposed to the user. The exemplary system accepts the input and proposes to the booking agent sets of best transportation options that satisfy all the requirements imposed by the booking agent. For each alternative, the exemplary system computes and displays different metrics such as total cost and total transit time. The exemplary system also computes and displays a measure of risk associated with each metric.

The exemplary system enforces business rules that have been previously defined. For example, if there is a preferred carrier, the exemplary system will first suggest alternatives using the preferred carrier and will only allow the booking agent to book with another carrier if certain predefined criteria are met (e.g., if the rate of the preferred carrier is more than 50% higher than the cost of an alternative carrier, the system may allow the user to book with the cheapest carrier).

The exemplary system can also recommend alternative transportation choices that do not necessarily satisfy all the requirements imposed by the booking agent but may be cost effective. Moreover, the exemplary system may recommend alternative transportation for which there is no complete cost information. These alternatives are suggested to the user and require the user to use other means to obtain the information needed to ascertain the interest of using such alternatives. For example, the user might need to call a certain carrier and ask for the rates for a specific route recommended by the system.

The exemplary system takes into account real time information regarding the state of the network when selecting the alternative transportation choices to present to the user. For example, if the exemplary system receives information that a strike is planned for a certain carrier, the system might recommend other carriers for a particular booking and/or alert the user that a certain carrier has an alert for a possible strike. If the user has updated information regarding any of the data such as rates or transit times, the user will be able to manually update the database. For example, the rate for specific truck transportation stored in the database might be different from the rate that the user can negotiate with a truck carrier. In that case, the user can manually enter the updated information and, if necessary, order the exemplary system to re-compute the recommendation.

The booking agent decides which option to choose and instructs the exemplary system to go ahead with that particular booking. The exemplary system automatically prepares the information necessary to proceed with the booking and sends that information to the transportation carriers selected. In one or more embodiments, this is done electronically by Electronic Data Interchange (EDI). In the unlikely case that carriers are not prepared to exchange data using EDI, then the information can be sent automatically by email.

Accordingly, one or more embodiments provide a method, system, and/or computer program product to automate end-to-end route composition for multi-modal freight booking requests. In some instances, several metrics for each route are calculated as a function of corresponding metrics for individual legs. In some such instances, land transportation cost is approximated using estimated cost per unit distance when exact costs are unknown.

Some embodiments account for carrier capacity constraints, carrier relationship constraints, volume discounts offered by carriers with those discounts being local or global, and/or shipper revenue targets.

Some embodiments pre-compute nearest port(s) for a land location for rapid response. Some embodiments make use of internal data as well as external data including shipping schedules.

One or more embodiments include any one, some, or all of the following features:
a) multi-objective optimization under uncertainty to find the best routes for a shipment request;
b) accounting for volume discounts offered by carriers;
c) accounting for real time network conditions;
d) accounting for risk factors.

One or more embodiments advantageously formulate the route identification problem using the framework of multi-objective optimization under uncertainty, thereby providing robust choices, which in turn improve network yield and resulting revenue.

One or more embodiments retrieve information in real time from external data sources and use it efficiently to calculate different metrics related to cost, transit time and risk. One or more embodiments provide a graphical user interface for input and output, functionality that allows the user to submit a booking to a carrier, and/or real time data obtained by electronic transfer from other systems.

One or more embodiments provide a booking system for multi-modal transportation which uses multi-objective optimization to find the best alternative routes for a particular shipment request. In one or more embodiments, for a particular booking request, the best routes are determined using optimization. Further, one or more embodiments support multi-modal transportation.

One or more embodiments provide an end-to-end optimization of the routing process, which takes into account various costs and routes along with carrier capacity and volume discounts. One or more embodiments deal with generation of optimized choices for an end-to-end route by accounting for static and dynamic information affecting the selection of routes. One or more embodiments describe a booking system that generates optimized routing alternatives for a specific shipment and presents those alternatives to the shipper. One or more embodiments include an optimization module that determines the best routes according to one or more criteria.

Furthermore, one or more embodiments provide a method and a system for end-to-end route composition by accounting for both static and real-time information. For each feasible route, one or more embodiments calculate a set of performance metrics and use these in an optimization framework to identify the best set of routes satisfying a business objective within specified performance constraints.

Yet further, one or more embodiments consider more complex metrics such as carrier capacity constraints and volume discounts along with costs to make an optimal route decision. One or more embodiments also consider multi modal freight route options (land, ocean, etc.) for optimal decisions.

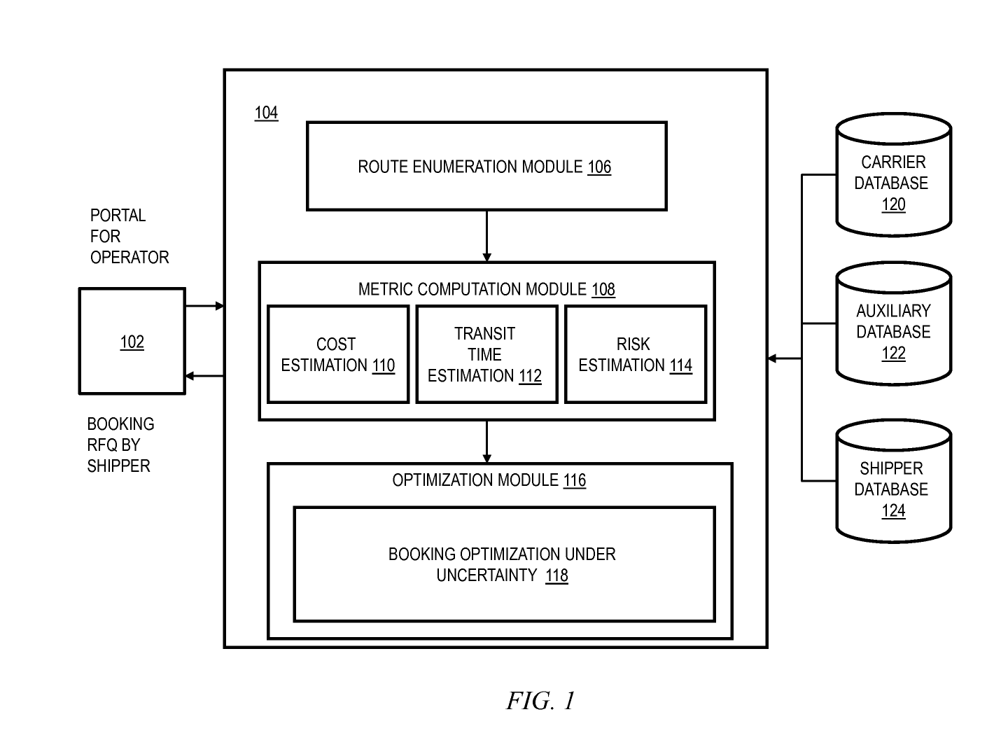

Referring now to FIG. 1, depicted therein is an exemplary system 104 in accordance with an aspect of the invention. System 104 includes route enumeration module 106, metric computation module 108, and optimization module 116. Metric computation module 108 in turn includes cost estimation sub-module 110, transit time estimation sub-module 112, and risk estimation sub-module 114. Optimization module 116 implements booking optimization under uncertainty, as seen at 118. Element 102 provides a portal (e.g., web-based) which allows an operator to access system 104. It also allows a shipper to send out requests for quotation (RFQs) for booking of shipments on one or more carriers.

Also included are carrier database 120 which includes pertinent information on one or more carriers; shipper database 124 which includes pertinent information on one or more shippers using the system 104, and auxiliary database 122 which includes information on, e.g., external factors such as local news (e.g., impending strike) and weather at destinations or along shipment routes.

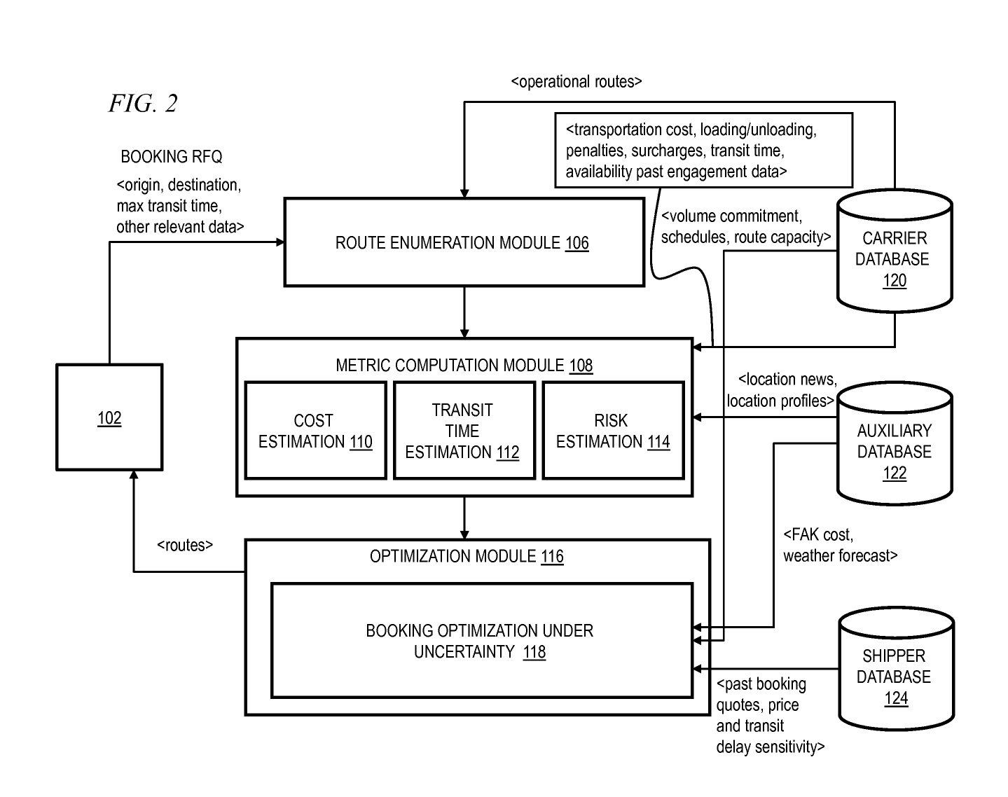

FIG. 2 presents an exemplary booking message flow according to an aspect of the invention. Element 102 communicates with route enumeration module 106 to provide same with appropriate data associated with a booking RFQ including origin, destination, maximum transit time and other relevant data. In some instances, so-called INCOTERMS can be employed; INCOTERMS are a set of rules that are used in international commerce with the purpose of clearly identifying some aspects of the transportation of goods such as responsibilities attributed to each entity involved in the transportation. Non-limiting examples of other relevant data include transit-time, carrier preference, date and time of loading and delivery, and number of twenty-foot equivalent units (TEUs). Route enumeration module 106 obtains information on operational routes from carrier database 120. Route enumeration module 106 then uses the inputs to generate feasible routes which are provided to metric computation module 108. Auxiliary database 122 provides location news and location profiles to metric computation module 108. Carrier database 120 provides transportation cost, loading and unloading penalties, surcharges, transit time, availability, free-time at ports, and past engagement data to metric computation module 108.

Optimization module 116 then carries out booking optimization under uncertainty as at 118, based on the cost, transit, and risk estimates from sub-modules 110, 112, 114 respectively. This optimization process also makes use of volume commitment, schedule, and route capacity information from carrier database 120; FAK cost and weather forecast data from auxiliary database 122; and past booking quotes, price and transit delay sensitivity data from shipper database 124. The skilled artisan will appreciate that “FAK” refers to “Freight All Kind” which is a carrier's rate that is used as a common rate for various goods. This output of the optimization process includes one or more routes displayed to the user via element 102.

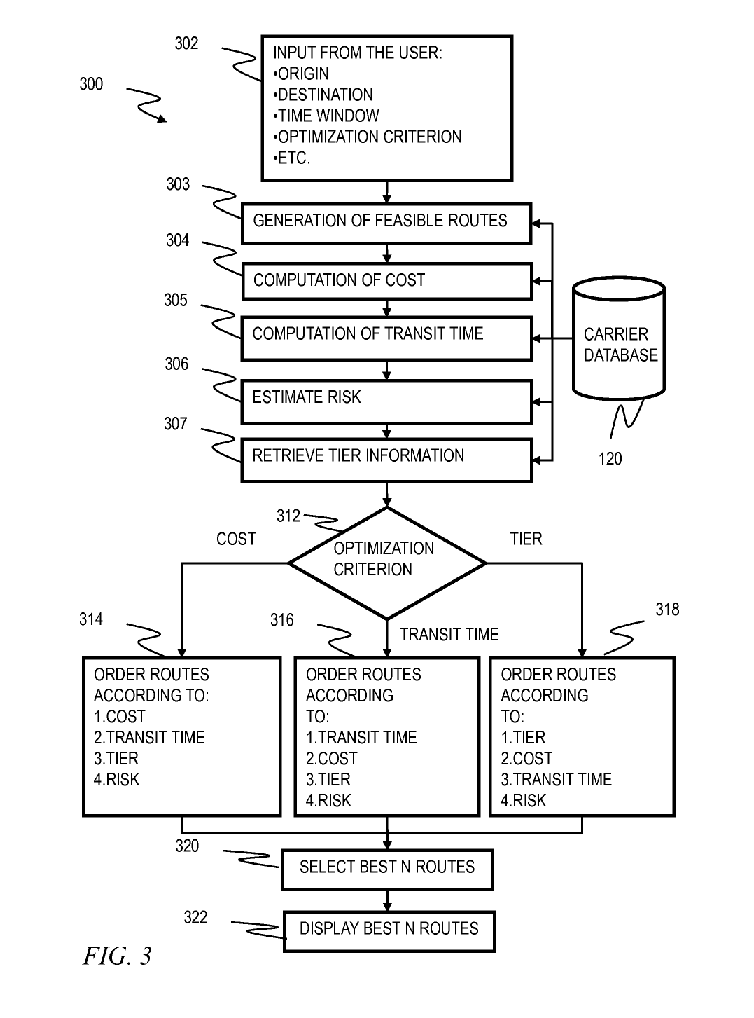

FIG. 3 depicts an exemplary flow chart 300 for booking according to an aspect of the invention. In step 302, a user provides input to system 104 via portal functionality of element 102. Exemplary input includes origin, destination, time window, what criterion/criteria (e.g., cost, speed, safety) to optimize on, and the like. Route enumeration module 106 then carries out step 303, generation of feasible routes, based on information from carrier database 120 as described elsewhere herein. Cost estimation sub-module 110 estimates cost in step 304, while transit time estimation sub-module 112 estimates transit time in step 305. Risk estimation sub-module 114 estimates risk in step 306. Optimization module 116 retrieves tier information from carrier database 120 in step 307.

In decision block 312, a decision is made whether to optimize for low cost (left-hand branch), low transit time (middle branch), or preferred tier (right-hand branch). “Tiers” refer to the case where a company codifies carriers according to preferences; for example, if a certain carrier allows a more favorable payment schedule (60 days instead of 30 days), that carrier may be preferred. Tier I may be most preferred carriers, Tier II may be less preferred, and so on (as many tiers as desired). These preferences are taken into account in the optimization. Module 116 makes the decision based on user input and then carries out the optimizations. As seen at step 314, if optimizing on cost, routes are ordered based first on lowest cost, then on lowest transit time, then on preferred tier, and then on risk. As seen at step 316, if optimizing on transit time, routes are ordered based first on lowest transit time, then on lowest cost, then on preferred tier, and then on risk. As seen at step 318, if optimizing on tier, routes are ordered based first on preferred tier, then on lowest cost, then on lowest transit time, and then on risk. The N best routes for the selected optimization criterion are determined by module 116 in step 320, and are displayed via portal functionality of element 102 in step 322. N is an arbitrary integer which can be hard-coded into the system or selected by the user; for example, the system may always give the best three (or other integer number of) choices in descending order of desirability, or may prompt the user with a query such as “how many alternatives do you wish to see). In some instances, all feasible routes may be displayed in ranked order.

It will be appreciated that system 104 provides a booking decision support tool which supports booking agents who have to respond with viable options to a request for freight transportation from a client. The tool takes as input a set of requirements that describe the transportation request and outputs a set of alternative routes. One non-limiting exemplary embodiments addresses ocean transportation of full container loads. It accommodates up to three ocean legs. One of those legs is usually an intercontinental leg on a large vessel from a major port in one continent (e.g., Shanghai in Asia) to a major port in another continent (e.g., Rotterdam in Europe). The other two legs usually involve smaller vessels going from a smaller port to a major port (or vice-versa) in the same continent (these are known as feeder legs). In addition to the ocean legs, in the non-limiting exemplary embodiments, a route may contain up to two truck legs. Truck legs are needed when the route includes transportation from an inland origin to a port and from a port to an inland destination. The different combinations of ocean and truck legs provide the tool with the capability to recommend routes for the following service types: Port to Port, Port to Door, Door to Port, and Door to Door.

A route includes a set of transportation legs. Each leg is described by its origin, its destination, the type of transportation, the type(s) of container(s) allowed, and time information. The time information available depends on the type of transportation. In the case of the ocean legs, specific schedules including departure date and arrival date are typically available. In the case of truck legs, typically, only estimates of the travel times are available. The time information for all legs in a route is combined with dwell times at ports in order to compute an estimated departure time from the route's origin, an estimated arrival time at the route's destination, and an estimated transit time for the whole route.

The cost of a route is the sum of the transportation rates for each leg and additional charges such as terminal handling charges, war risk charges, etc. Both the transportation rates and the additional charges may depend on the type of container to be used in the shipment. Therefore, the type of container (e.g., 20 foot or 40 foot container) is one of the inputs to the booking tool. Some carriers offer volume discounts, which are typically applied based on the annual volume shipped by a client. In that case, the calculation of the cost for a particular shipment request depends on the number of containers already shipped by the client on that carrier during that year. The transportation rates might also depend on the commodity to be shipped and on the existence of specific contracts between the shipper and the carrier.

For a particular transportation request, the number of routes that can fulfill the request are limited by the constraints imposed in the request. One non-limiting exemplary embodiment of a booking tool supports the following constraints:
Time window—each route has to fit within a time window specified by the user.
Total transit time—the estimated transit time of each route must be smaller than a maximum transit time specified by the user.
Include port—each route has to go through a particular port specified by the user.
Exclude port—each route must not go through a particular port specified by the user.
Include carrier—the ocean transportation in each route must be provided by a particular carrier specified by the user.
Exclude carrier—the ocean transportation in each route must not be provided by a particular carrier specified by the user.

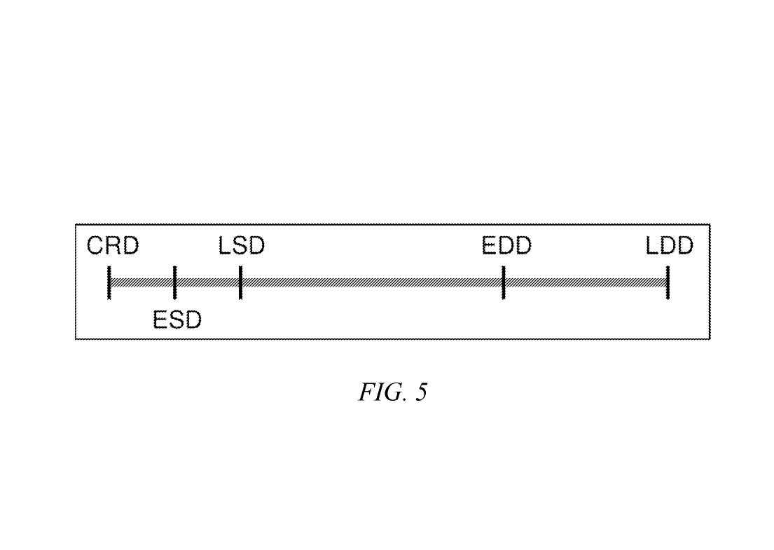

In a non-limiting exemplary embodiment, the time window is specified by the user by providing the following dates (see FIG. 5):
Cargo Ready Date (CRD)—the date when the cargo is available for shipment.
Earliest Ship Date (ESD)—the earliest date when the shipment can depart.
Latest Ship Date (LSD)—the latest date when the shipment can depart.
Earliest Delivery Date (EDD)—the earliest date when the shipment can arrive at the destination.
Latest Delivery Date (LDD)—the latest date when the shipment can arrive at the destination.

Depending on the business needs, the user may provide only a subset of the above dates. For example, the user may provide only the Cargo Ready Date and the Latest Delivery Date. In this case, the routes generated by the booking tool must depart at or after the Cargo Ready Date and must arrive at or before the Latest Delivery Date. It should be noted that if both the Cargo Ready Date and the Earliest Ship Date are provided by the user, the routes must depart at or after the latest of those two dates. If only one of them is provided, the routes must depart at or after that date.

Amongst the routes that satisfy the constraints of a transportation request there are usually some that are preferable than others from a business perspective. A non-limiting exemplary embodiment of the booking tool includes three metrics for evaluating the routes: (i) Cost, (ii) Transit time, and (iii) Tier.

The estimation of the first two metrics (cost and transit time) is described elsewhere herein. The third metric, tier, classifies a route based on the ocean carrier used. The user may prefer certain carriers over others and therefore can attribute a higher tier level to the preferred carriers. The decision on the tier of each carrier depends on the business needs and can be based on many different aspects of the carrier. For example, it can be based on the payment terms provided by the carrier or the percentage of the time that the shipments on the carrier arrive on time. It can also be based on a combination of several aspects of the carrier.

The user of the booking tool chooses a criterion for selection of the best routes based on the three metrics available. The options are: (i) Minimum cost, (ii) Minimum transit time, and (iii) Higher tier carrier. Whatever the criterion selected by the user, the booking tool outputs the details of the three best routes. With this information the user can decide which route (or possibly which routes) to use for the shipment.

FIGS. 1 and 2 present a diagram of the exemplary booking tool. The tool connects to databases 120, 122, 124 where all the data needed is stored. The tool also provides a graphical user interface (via element 102) where the user enters the information about the transportation request and where the output (i.e., the best routes found) is displayed.

The modules and sub-modules of system 104 carry out at least a portion of the sequence of steps in the tool to find the best routes. The route enumeration module 106 corresponds to the construction of the feasible routes; the metric computation module 108 corresponds to the estimation of the three metrics, and the optimization module 116 corresponds to the selection of the best routes to present to the user.

In the route enumeration module 106, an enumeration algorithm is used that basically constructs feasible routes one at a time by selecting transportation legs from the database 120 that when put together satisfy all the constraints specified by the user. The output of this module is a set of feasible routes, i.e., a set of routes that satisfy all the constraints.

In the metric computation module 108, the three metrics described above (cost, transit time, and tier) are computed for all the routes generated in the route enumeration module.

Finally, in the optimization module 116 the best routes are selected from the above set of feasible routes. In a non-limiting exemplary embodiment, the optimization module sorts the feasible routes according to the criterion selected by the user (as discussed above). For example, if the user selects the criterion of minimum cost routes, then the feasible routes are ordered according to increasing cost and the tool outputs the first three routes of the sorted list, i.e., the three cheapest routes in the list.

Given the discussion thus far, it will be appreciated that, in general terms, an exemplary method, according to an aspect of the invention, includes the step 302 of obtaining, from a user (e.g., via element 102), booking information specifying a desired multi-modal freight shipment. The information includes at least destination and origin. A further step 303 includes, based on the booking information and route information from a carrier database 120, generating, with a route enumeration module 106, a plurality of feasible multi-modal routes for the desired freight shipment. A still further step 304 includes, based on cost information from the carrier database 120, computing cost for each of the feasible multi-modal routes with a cost estimation sub-module 110 of a metric computation module 108. An even further step 305 includes, based on transit time information from the carrier database 120, computing transit time for each of the feasible multi-modal routes with a transit time estimation sub-module 112 of the metric computation module 108. Yet a further step 312-320 includes, based on the cost for each of the feasible multi-modal routes and the transit time for each of the feasible multi-modal routes, carrying out multi-objective optimization under uncertainty with an optimization module 116, to obtain one or more preferred ones of the feasible multi-modal routes.

The word “multi-modal” indicates that the routes generated can include more than one mode of transportation. A simple example of multi-objective optimization is to find the route with lowest cost from the set of routes with smallest transit time. In a case where there are 10 routes with smallest transit time (e.g., 11 days), return the one route out of those 10 that has lowest cost. An example of uncertainty is the possibility of a surcharge being applied to the cost of the route after the route is booked. For each route, take as a given a probability of a surcharge being applied to its cost and if the optimization engine is asked to minimize cost it will select the route with the lowest expected cost. For example, a route that costs $1000 with a 10% probability of a $100 surcharge (has expected cost of $1010) is preferable to a route that costs $950 with an 80% probability of a $100 surcharge (has expected cost of $1030).

In some instances, a further step 307 includes retrieving tier information from the carrier database 120; in such cases, carrying out of the multi-objective optimization under uncertainty with the optimization module takes into account the tier information.

In some instances, a further step 306 includes, based on location-specific information from an auxiliary database 122, computing risk for each of the feasible routes with a risk estimation sub-module 114 of the metric computation module 108; in such instances, the multi-objective optimization under uncertainty is further based on the risk for each of the feasible routes.

In some cases, the cost information from the carrier database 120 includes volume discounts offered by at least one carrier, and the computing of the cost for each of the feasible routes with the cost estimation sub-module 110 of the metric computation module 108, in step 304, takes the volume discounts into account for at least one of the feasible routes.

In some cases, the multi-objective optimization under uncertainty is further based on real-time network conditions.

In some cases, a further step includes flagging at least one of the preferred ones of the feasible multi-modal routes based on real-time network conditions.

For example, if the system knows that a port currently has a limited throughput due to construction then it can give priority to routes that do not use that port or/and flag all the routes that go through that port so that the user can make an informed decision. In summary, the information about real time network conditions can be used to influence the optimization and also as additional information given to the user about conditions affecting specific routes.

Further steps in one or more embodiments include booking shipment of goods based on the output and/or actually shipping goods in accordance with a recommendation from the system.

In another aspect, an exemplary apparatus (e.g., system 412 implementing system 104) includes a memory 404 including a carrier database 120 and a plurality of distinct software modules. The plurality of distinct software modules in turn include an input-output module (e.g. provided by element 102), a route enumeration module 106, an optimization module 116, and a metric computation module 108 having a cost estimation sub-module 110 and a transit time estimation sub-module 112. At least one processor 402 is coupled to the memory, and is operative to carry out or otherwise facilitate any one, some, or all of the method steps disclosed herein.

In some cases, the memory further includes an auxiliary database 122 and/or a shipper database 124, and/or a risk estimation sub-module 114 of the metric computation module 108.

One or more embodiments of the invention, or elements thereof, can be implemented in the form of an apparatus including a memory and at least one processor that is coupled to the memory and operative to perform exemplary method steps.

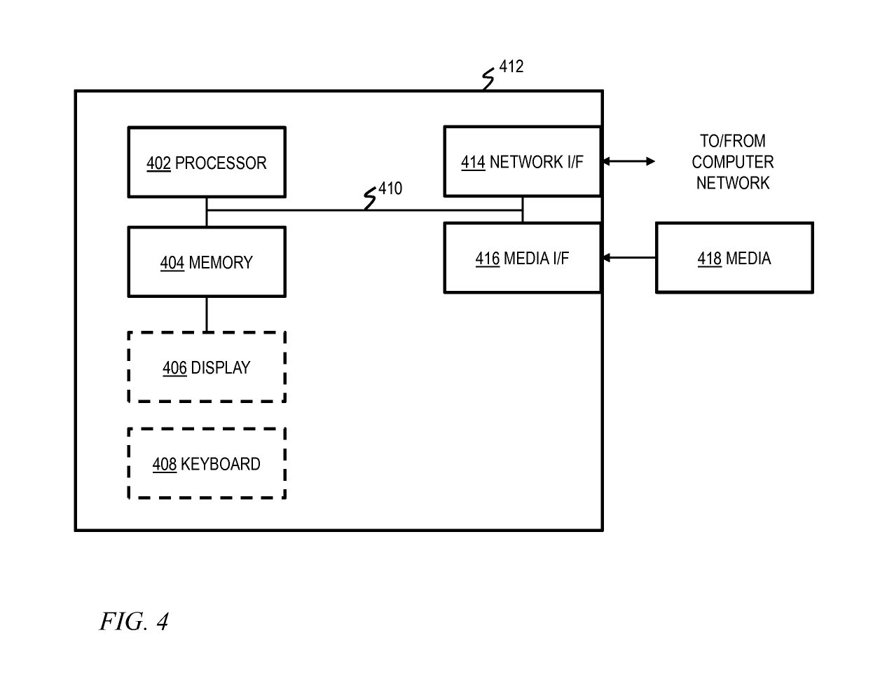

One or more embodiments can make use of software running on a general purpose computer or workstation. With reference to FIG. 4, such an implementation might employ, for example, a processor 402, a memory 404, and an input/output interface formed, for example, by a display 406 and a keyboard 408. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, one or more mechanisms for inputting data to the processing unit (for example, mouse), and one or more mechanisms for providing results associated with the processing unit (for example, printer). The processor 402, memory 404, and input/output interface such as display 406 and keyboard 408 can be interconnected, for example, via bus 410 as part of a data processing unit 412. Suitable interconnections, for example via bus 410, can also be provided to a network interface 414, such as a network card, which can be provided to interface with a computer network, and to a media interface 416, such as a diskette or CD-ROM drive, which can be provided to interface with media 418.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 402 coupled directly or indirectly to memory elements 404 through a system bus 410. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 408, displays 406, pointing devices, and the like) can be coupled to the system either directly (such as via bus 410) or through intervening I/O controllers (omitted for clarity).

Network adapters such as network interface 414 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 412 as shown in FIG. 4) running a server program. It will be understood that such a physical server may or may not include a display and keyboard.

It should be noted that any of the methods described herein can include an additional step of providing a system comprising distinct software modules embodied on a computer readable storage medium; the modules can include, for example, any or all of the elements depicted in the block diagrams or other figures and/or described herein (e.g., modules and sub-modules shown in FIGS. 1-3). The method steps can then be carried out using the distinct software modules and/or sub-modules of the system, as described above, executing on one or more hardware processors 402. Further, a computer program product can include a computer-readable storage medium with code adapted to be implemented to carry out one or more method steps described herein, including the provision of the system with the distinct software modules. In addition, databases 120, 122, 124 typically include records in persistent storage accessed by database management system software. The portal provided by element 102 may include hypertext markup language served out by a server to one or more client computers which, when executed on a browser of the client computer, creates a graphical user interface (GUI).

### Exemplary System and Article of Manufacture Details

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1.-6. (canceled)

7. An apparatus comprising:
a memory including a carrier database and a plurality of distinct software modules, said plurality of distinct software modules in turn comprising an input-output module, a route enumeration module, an optimization module, and a metric computation module having a cost estimation sub-module and a transit time estimation sub-module; and
at least one processor, coupled to said memory, said at least one processor being operative to:
obtain, from a user, using said input-output module executing on said at least one hardware processor, booking information specifying a desired multi-modal freight shipment, said information including at least destination and origin;
based on said booking information and route information from said carrier database, generate, using said route enumeration module executing on said at least one hardware processor, a plurality of feasible multi-modal routes for said desired freight shipment;
based on cost information from said carrier database, compute cost for each of said feasible multi-modal routes using cost estimation sub-module of said metric computation module executing on said at least one hardware processor;
based on transit time information from said carrier database, compute transit time for each of said feasible multi-modal routes with said transit time estimation sub-module of said metric computation module executing on said at least one hardware processor; and
based on said cost for each of said feasible multi-modal routes and said transit time for each of said feasible multi-modal routes, carry out multi-objective optimization under uncertainty with said optimization module executing on said at least one hardware processor, to obtain one or more preferred ones of said feasible multi-modal routes.

8. The apparatus of claim 7, wherein said at least one processor is further operative to retrieve tier information from said carrier database, wherein said carrying out of said multi-objective optimization under uncertainty with said optimization module takes into account said tier information

9. The apparatus of claim 7, wherein said memory further includes an auxiliary database and a risk estimation sub-module of said metric computation module, and wherein said at least one processor is further operative to:
based on location-specific information from said auxiliary database, compute risk for each of said feasible routes with said risk estimation sub-module of said metric computation module;
wherein said multi-objective optimization under uncertainty is further based on said risk for each of said feasible routes.

10. The apparatus of claim 7, wherein said cost information from said carrier database includes volume discounts offered by at least one carrier, and wherein said computing of said cost for each of said feasible routes with said cost estimation sub-module of said metric computation module takes said volume discounts into account for at least one of said feasible routes.

11. The apparatus of claim 7, wherein said multi-objective optimization under uncertainty is further based on real-time network conditions.

12. The apparatus of claim 7, wherein said at least one processor is further operative to flag at least one of said preferred ones of said feasible multi-modal routes based on real-time network conditions.

13. A computer program product comprising a computer readable storage medium having program instructions embodied therewith, wherein the computer readable storage medium is not a transitory signal per se, and wherein the program instructions are executable by a processor to cause the processor to perform a method comprising:
obtaining, from a user, booking information specifying a desired multi-modal freight shipment, said information including at least destination and origin;
based on said booking information and route information from a carrier database, generating, with a route enumeration module, a plurality of feasible multi-modal routes for said desired freight shipment;
based on cost information from said carrier database, computing cost for each of said feasible multi-modal routes with a cost estimation sub-module of a metric computation module;
based on transit time information from said carrier database, computing transit time for each of said feasible multi-modal routes with a transit time estimation sub-module of said metric computation module; and
based on said cost for each of said feasible multi-modal routes and said transit time for each of said feasible multi-modal routes, carrying out multi-objective optimization under uncertainty with an optimization module, to obtain one or more preferred ones of said feasible multi-modal routes.

14. The computer program product of claim 13, wherein said method performed by said program instructions executable by said processor further comprises retrieving tier information from said carrier database, wherein said carrying out of said multi-objective optimization under uncertainty with said optimization module takes into account said tier information

15. The computer program product of claim 13, wherein said method performed by said program instructions executable by said processor further comprises:
based on location-specific information from an auxiliary database, computing risk for each of said feasible routes with a risk estimation sub-module of said metric computation module;
wherein said multi-objective optimization under uncertainty is further based on said risk for each of said feasible routes.

16. The computer program product of claim 13, wherein said cost information from said carrier database includes volume discounts offered by at least one carrier, and wherein said computing of said cost for each of said feasible routes with said cost estimation sub-module of said metric computation module takes said volume discounts into account for at least one of said feasible routes.

17. The computer program product of claim 13, wherein said multi-objective optimization under uncertainty is further based on real-time network conditions.

18. The computer program product of claim 13, wherein said method performed by said program instructions executable by said processor further comprises flagging at least one of said preferred ones of said feasible multi-modal routes based on real-time network conditions.
